(19) United States
(12) Patent Application Publication
(10) Pub. No.: US 2026/0166556 A1
(43) Pub. Date: Jun. 18, 2026

(54) CORNER BLOCK SEGMENT FOR A ROLL OF A COMMINUTION DEVICE

(71) Applicant: FLSmidth A/S, Valby (DK)

(72) Inventors: Nils Horster, Ennigerloh (DE); Daniel Wortmann, Werne (DE); Silvio Lorenz, Ennigerloh (DE); Frank Schroers, Ahlen (DE); Matthias Janssen, Ostbevern (DE)

(21) Appl. No.: 19/125,271

(22) PCT Filed: Oct. 30, 2023
(86) PCT No.: PCT/IB2023/060906

§ 371 Date: Apr. 28, 2025

(30) Foreign Application Priority Data
Oct. 28, 2022 (BE) 2022/5888
Oct. 28, 2022 (DE) 10 2022 128 769.6

(51) Int. Cl. B02C 4/30; B02C 4/02

(52) U.S. Cl. CPC B02C 4/305; B02C 4/02

(57) ABSTRACT

The invention relates to a corner block segment (2) for attachment to a cylindrical roll body (104) of a roll (102) of a comminution device (100), the corner block segment (2) having a base body (4), a segment outer side (8), a segment end face (12), a corner region (10) between the segment outer side (8) and the segment end face (12) to form a roll edge (110) of the roll (102), and a receiving side (14), wherein the receiving side (14) corresponds to a segment receptacle (106) of the roll body (104) and is arranged facing away from the corner region (10), wherein the segment outer side (8) is curved and is arranged facing away from an imaginary reference axis (16), and wherein in the longitudinal section through the reference axis (16), the corner region (10) has a radius (18) of at least 5 mm.

The invention relates to a corner block segment for attachment to a roll body of a roll of a comminution device for comminuting material to be comminuted, wherein the roll is designed to rotate about a central axis of the roll. To form a roll edge of the roller, the corner block segment has a corner region. The invention further relates to a roll with the corner block segment, a comminution device with the corner block segment, a system with the corner block segment and an edge body for the corner block segment.

The comminution device is intended in particular for comminuting material to be comminuted such as hard rock or raw materials in the stone and earth industry, in ore and natural stone processing, in mining and/or in the cement industry. The material to be comminuted is in particular ores, for example iron ore, copper ore and/or gold ore. The material to be comminuted (also: material to be ground, or ore) is usually lumpy and/or granular.

The comminution device is in particular a roll mill and/or a roller press. In particular, the comminution device can be used to carry out a high-pressure treatment of the material to be comminuted or the granular material to be ground. In the comminution device, material to be comminuted is typically comminuted between two rolls that are arranged at least substantially parallel and rotate or can be rotated in opposite directions.

When comminuting using rolls in the comminution device, the rolls are exposed to wear. In particular, the roll edges wear particularly strongly with respect to an outer surface of the roll, i.e. the region between the roll edges. In order not to have to replace an entire roll, it has proven useful to form the roll edge using a plurality of corner block segments detachably attached to the roll body. The corner block segments are usually shaped substantially in the shape of a ring section or disk section, so that a plurality of them can be assembled substantially into a ring or into a disk. The roll edge can be renewed by replacing the corner block segments.

The disadvantage of using the corner block or the corner block segments is that material to be comminuted can penetrate into the region between an individual corner block segment and the roll body during comminution or when replacing the corner block segment, which can make assembly or disassembly more difficult. In particular, if the corner block segment does not rest flatly or evenly on the roll body, or even if the corner block segment is deformed in particular elastically during comminution, damage to the corner block segment and/or roll body can occur.

Therefore, the object of the invention is to provide a corner block segment, a roll, a comminution device and a system in which the disadvantages of the prior art are avoided or at least substantially reduced. In particular, the corner block segment should have improved resistance to wear and/or make the roll even more durable.

According to the invention, the object is achieved by a corner block segment according to claim 1, a roll according to claim 9, a comminution device according to claim 12, a system according to claim 14 and an edge body according to claim 15. Advantageous developments of the invention are specified in the dependent claims.

A corner block segment is proposed for attachment to a cylindrical roll body of a roll of a comminution device for comminuting material to be comminuted. Here, the roll is designed to rotate about a central axis of the roll. The corner block segment has: a base body, a segment outer side attached to the base body, a segment end face attached to the base body, a corner region between the segment outer side and the segment end face attached to the base body to form a roll edge of the roll, and a receiving side attached to the base body.

In this case, the receiving side corresponds to a segment receptacle of the roll body and is arranged facing away from the corner region, wherein the corner block segment is at least substantially shaped like a sector of a circular ring or a sector of a circle about an imaginary reference axis of the corner block segment, wherein the segment outer side is curved and is arranged facing away from the reference axis, and wherein in the longitudinal section through the reference axis the corner region has a radius of at least 5 mm, and, preferably, in the longitudinal section through the reference axis, the segment outer side has at least one section that is pointed towards the corner region.

The receiving side corresponds to a segment receptacle of the roll body and is arranged facing away from the corner region. The corner block segment is at least substantially shaped like a ring sector or disk sector about an imaginary reference axis of the corner block segment. The segment outer side is curved. The segment outer side is arranged facing away from the reference axis. In the longitudinal section through the reference axis—i.e. parallel to the reference axis—the corner region has a radius of at least 5 mm. In the longitudinal section through the reference axis, the segment outer side can have at least one section that is pointed towards the corner region.

In particular, it is proposed that the corner region is rounded at least in sections and/or is designed convex. In particular, the corner region should not have sharp edges. This ensures a longer service life for the corner block segment without compromising the quality of the comminution. It has been shown that with a radius of at least 5 mm, the comminution force resulting from the material to be comminuted on the roller, which is generally directed substantially radially, can easily be directed in an axial direction. The result is that the corner block segment experiences a force along the central axis, which can press the corner block segment itself against the roll body and thus avoid the formation of a gap between the corner block segment and the roll body. Even better results have been achieved when the radius adjoins the pointed section, i.e. when the segment outer side tapers towards the radius. This additionally reduces the size of the lever on which the comminution forces can act to deform the corner block segment away from the roll body, and this also reduces the comminution forces arising on the corner block segment by means of a locally enlarged working gap.

In particular, the base body is metallic. It has been shown to be advantageous, particularly with metallic base bodies, that particularly good service lives are achieved for the corner block segment. The metallic base body can be attached to the screw connection, for example, by screwing with high torques without being damaged.

Because the receiving side corresponds to a segment receptacle of the roll body, the corner block segment can be received as precisely as possible by the roll body. In particular, this means that the segment receptacle corresponds in sections to a shape of the receiving side, so that the segment receptacle can lie flat against the receiving side. For example, the segment receptacle and the receiving side are each, preferably in longitudinal section through the reference axis or central axis, at least substantially and/or in sections L-shaped.

A corner block segment is a product, a plurality of which can form a ring- or disk-shaped 5 assembly. The individual corner block segments are in particular part of a ring to be formed or a disk to be formed. Each corner block segment covers in particular a sector or a segment around the central axis or the reference axis. Because the corner block segment is intended to provide a roll edge, i.e. a corner of the roll, it specifically contains (the word) “corner”. Because the corner block segment is substantially block-shaped, it specifically contains (the word) “block”. Block-shaped here means that the segment is selected to be so small, for example in the range of 5° up to 15°, in particular 10°+/−2.5 ° around the central axis or the reference axis, that it is more block-shaped than ring segment-shaped or disk segment-shaped, because the curvature appears insignificant or disappears from a purely visual perspective.

The segment receptacle is in particular provided all around on one or both roll end faces. The segment receptacle can be designed L-shaped. The segment receptacle can be provided with openings pointing in particular parallel to the central axis, to which the corner block segment can be attached or screwed. A plurality of corner block segments can be accommodated next to each other in the segment receptacle in order to fill the segment receptacle and form the edge of the roll. For example, 36 corner block segments can be accommodated in a segment receptacle, as long as each corner block segment extends over a 10° circumferential angle around the central axis or its reference axis. Circumferential angles of 5° to 30° or even more are also possible.

A plurality of corner block segments can be placed against each other via contact sides or contact surfaces of the corner block segments. The contact sides can be profiled and/or at least substantially flat. Contact sides of two corner block segments that are opposite or facing each other can be designed to correspond to one another. The contact sides can be present on the base body and/or on the edge body. The contact sides run at least substantially parallel to the reference axis and/or at a distance from the reference axis.

The imaginary reference axis typically lies outside the physical extent of the corner block segment. The reference axis typically runs transversely to the segment end face and/or at least substantially parallel to the segment outer side. The imaginary reference axis should coincide with the central axis of the roll so that the corner block segment fits well into the roll body and creates as little imbalance as possible and can provide the roll edge.

The roll is designed typically at least substantially cylindrical. The central axis runs in the middle of the roll. In particular, the central axis runs at least substantially vertically

through the roll end faces and/or is surrounded by the outer side of the roll. The roll can rotate about the central axis-in particular at least substantially without any significant imbalance. The roll preferably has a diameter of 0.5 m to 6 m. The roll is particularly preferably equipped with a diameter of 0.95 m to 3 m.

The roll body has, for example, steel. In particular, the roll body has or consists of forged steel. In particular, the roll or the roll body can be made of a steel with the designation 18NiCrMo14-6.

The base body of the corner block segment preferably has metal or consists of it. For example, the base body can be made from steel of grade S355. Something can easily be soldered to this base body. In addition, the base body is inexpensive in this way and can be easily processed using separating manufacturing processes.

The segment outer side is curved, especially around the reference axis. The segment outer side is to be understood as meaning a side of the corner block segment which is typically directed radially outwards in order to come into contact with the material to be comminuted. Facing away from the segment outer side, specifically viewed in a longitudinal section through the reference axis, is in particular a part of the receiving side.

The segment end face is typically directed outwards in the axial direction along the reference axis or the central axis in order to come into lateral or end face contact with the material to be comminuted. Facing away from the segment end face and namely in the longitudinal section through the reference axis is a part (or the remaining part) of the receiving side.

The corner region is arranged in particular between the segment outer side and the segment end face. In particular, in the longitudinal section through the reference axis, the segment outer side and the segment end face border opposite to the corner region or only indirectly border one another. In particular, the corner region cannot necessarily be clearly delimited from the segment outer side and the segment end face. This is typically because the sides mentioned and the corner region should merge into one another as continuously or smoothly as possible. Particularly because the corner region has a radius, it cannot always be clearly and unambiguously separated from the segment outer side, which may taper towards the corner region. In any case, the invention relates to the fact that the corner block segment is rounded in the region in which the roll edge is formed in order to bring about an axial force component in the direction of the roll body during comminution.

In particular, the invention also covers the case where the segment end face, the corner region and the segment outer side partially or completely overlap.

The receiving side can be arranged partially facing away from the segment end face and partially facing away from the segment outer side. In particular, the receiving side is arranged facing away from the corner region, that is to say in particular: the receiving side and the corner region are arranged on diametrically opposite sides of the corner block segment.

The segment end face is in particular arranged at least substantially transversely to the segment outer side and/or to the reference axis. The corner region can form a transition between the segment end face and the segment outer side.

The segment outer side, in particular the pointed section, is conically shaped, for example. In particular, the segment outer side or the pointed section tapers in the direction of the corner region and/or in the direction of the segment outer side.

According to a modified embodiment, it is provided that the radius of the corner block segment is at least 10 mm and/or up to and including 40 mm, preferably at least 20 mm and/or up to and including 30 mm. In other words, it is possible for the radius to be at least 10 mm and/or up to and including 40 mm, preferably at least 20 mm and/or up to and including 30 mm. This ensures that the corner block segment can rest even better on the roll body. A radius of 25 mm+/−2 mm is particularly preferably provided so that it can also be used with different diameters of rolls with good results.

According to a modified embodiment, it is provided that the segment outer side is conical and/or the segment outer side adjoins the corner region in particular seamlessly and/or continuously.

According to a modified embodiment, it is provided that the pointed section, in particular seamlessly and/or continuously, adjoins a cylinder sleeve section-shaped section of the segment outer side.

If the pointed section is designed conical and/or the pointed section adjoins the corner region, in particular seamlessly and/or continuously, a particularly favorable material load can be achieved. The probability of breakage is significantly reduced because material fatigue is significantly delayed due to lower maximum loads. In particular, the pointed section can be designed in the shape of a cylinder sleeve section or cylinder sleeve sector. The transition from the pointed section and radius should be seamless or edgeless or continuous, i.e. substantially without an abrupt change in incline in the longitudinal section through the reference axis.

If the pointed section, in particular seamlessly and/or continuously, adjoins a section of the segment outer side that is at least substantially in the form of a cylinder sleeve section, the transition to the roll body can also be configured inexpensively. Because the roll body has a mostly substantially cylindrical roll outer side or roll outer surface, the cylinder sleeve section-shaped section can merge flatly or evenly into the roll outer side or roll outer surface. This also improves the mechanical properties and increases the service life of the roll.

According to a modified embodiment, the corner block segment has at least one edge body connected, in particular soldered, to the base body. The edge body in particular has hard metal and/or tungsten carbide or consists of hard metal and/or tungsten carbide or is made from it. In particular, material can be saved and a highly stable and wear-resistant corner block segment can be provided. Soldering in particular represents a particularly robust and suitable connection and is preferable to welding and screwing due to its longevity and easy reprocessing options.

Alternatively or additionally, it is possible for the base body and the edge body to be designed monolithically or in one piece. Basically, the theoretical distinction between the base body and the edge body can be difficult or even impossible. In this respect, the base body can make use of the features of the edge body. The base body can—at least in sections—have hard metal or be made from it. The base body can have—at least in sections—the segment outer side, the corner region, the segment end face and/or the receiving side.

To connect the base body to the edge body or to the edge bodies, a projection and a recess corresponding to the projection can be provided. The projection and recess can each be provided on the base body or edge body and/or designed to engage one another. The projection or the recess can be part of the base body and/or the edge body, in particular designed in one piece or monolithically with it. The connection can be strengthened by having a larger area in contact with each other. In particular, a positive fit can be provided.

The projection is preferably provided on the edge body in order to engage in the recess on the base body. This arrangement leads to the greatest possible force transmission along the central axis or reference axis, because the projection can then consist of the material of the edge body, which is usually harder than the base body. The projection can then remain small in order to transmit the forces and without having to fear material failure. In the case that the projection is provided on the base body, there is usually a material on the projection that is more ductile than the edge body, which therefore has to be designed differently or has to be dimensioned larger. Nevertheless, both arrangements are possible.

When the projection and recess correspond to one another, this means that the projection and recess are designed to be uniform at least in sections, so that the segment receptacle can lie flat against the receiving side, and/or so that there can be a positive connection in one direction, for example along the reference axis. For example, the projection and the recess are each at least substantially U-shaped, preferably in a longitudinal section through the reference axis or central axis.

The projection and/or the recess can be curved about the reference axis. The projection and/or the recess can extend around the reference axis in a plane orthogonal to the reference axis. This makes it easier to position individual edge bodies next to each other on a base body that is to be connected or soldered to a plurality of edge bodies.

Thanks to the projection and the recess, the edge body and base body can be guided together. This makes it easier to connect the base body and the edge body with a precise fit, so that the corner block segment can be accommodated in the segment receptacle with as close a fit as possible with both the base body and the edge body, without unwanted gaps forming.

It is possible that the base body has the corner region and/or the segment outer side. The edge body can also be dispensed with entirely. The base body can thus be provided with any properties of the edge body described here.

The edge body can have the corner region and/or the segment outer side. In this case in particular, it is ensured that the corner block segment is particularly wear-resistant because the already wear-resistant edge body now also has the corner region that is generally very subject to wear or the segment outer side that is very subject to wear.

According to a modified embodiment, it is provided that the base body has an opening extending along the reference axis for detachable connection to the roll body, for example by screwing. The opening can also be provided in the edge body. The opening is well suited for attachment to the roll body by screwing. The opening can be provided with a depression for a screw head so that the screw head does not protrude from the corner block segment or only protrudes insignificantly.

A roll is also proposed. The roll is intended for a comminution device for comminuting material to be comminuted and is designed to rotate about a central axis of the roll. The roll has: at least one corner block segment according to one of the above-described embodiments, individually or in combination: a cylindrical roll body with a segment receptacle for the corner block segment, wherein the roll body has two roll end faces facing away from one another along the central axis, and is designed with a roll outer side extending between the roll end faces, and forming a cylinder sleeve, wherein the segment receptacle is arranged on at least one of the roll end faces for the corner block segment to form a roll edge through the corner region of the corner block segment, wherein the corner block segment is received in the segment receptacle in such a way that the reference axis and the central axis are coaxial or run parallel.

So that the central axis and the reference axis can run parallel when the corner block segment is accommodated in the segment receptacle, the segment receptacle should be constructed to be curved all the way around the central axis. The segment receptacle should have a distance from the central axis that corresponds to the distance of the corner block segment or the physical components of the corner block segment to the reference axis. In other words, the segment receptacle should be curved in the same way as the corner block segment. Alternatively or additionally, the segment receptacle in the cross-section through the central axis should substantially correspond to a surface of the corner block segment in the cross-section through the reference axis. Then the reference axis and the central axis can simply and safely run coaxially or parallel.

According to a modified embodiment, it is provided that the roll body has receptacles for wear bodies and/or connecting regions for wear bodies which point transversely to the central axis and are accessible on the roll outer side and distributed around the circumference on the roll outer side. The receptacles can be designed cylindrical. In a simple case, the receptacles are bores and/or blind holes. The connecting regions can have connecting means for connecting to the wear bodies. For example, mutually corresponding projections and recesses can be provided as connecting means. The connecting regions can be provided in the receptacles.

For example, the receptacles can be distributed around the central axis and/or along the central axis on the roll body or the roll, preferably in such a way that the roll outer side is at least substantially covered by the receptacles, preferably with an area proportion of at least 10%, 20%, 30%, 50% or more. For example, the receptacles can in particular be arranged rotationally symmetrically distributed along a circle of rotation of the roll body or roll around the central axis that is imaginary/formed. A plurality of these circles of rotation can be provided distributed along the central axis. Adjacent circles of rotation can have the same number of receptacles and/or can be rotated relative to one another by half an angular distance between individual receptacles adjacent in a circle of rotation. In this way, large-area wear protection on the roll outer side can be achieved.

According to a modified embodiment, it is provided that the roll has the wear bodies on the roll outer side. In particular, the wear bodies are inserted in the receptacles. Alternatively or additionally, the wear bodies are connected to the receptacles. Alternatively or additionally, the wear bodies are connected to the connecting regions. During insertion or connection, the wear body can, for example, be soldered or glued. The wear bodies preferably have hard metal and/or are designed cylindrical and/or rod-shaped and/or bolt-shaped.

Thanks to the wear bodies, the roll body or the roll can also be well protected from wear in the region of the roll outer side without having to use an unnecessary amount of wear-resistant material.

The wear bodies therefore serve as a type of hard substance on the roll body, while the roll body, which is typically more ductile or less hard than the wear bodies, is thereby protected.

Furthermore, a comminution device for comminuting material to be comminuted is proposed. The comminution device is equipped with a drive unit and with two rolls that can rotate parallel to each other in opposite directions about a central axis and can be driven by the drive unit. Here, the rolls are designed and arranged in such a way that an adjustable working gap for comminution is formed between the rolls, wherein the first roll is designed according to one of the modified embodiments described above. Here, for example, the second roll has radially projecting side walls to limit the working gap along the central axes.

The comminution device typically has an input power or drive power in the range of 100 kW to 10,000 kW. For comminution in the comminution device, an average size of the feed material to be comminuted in the range of 5 to 10 cm, in particular 6 to 8 cm, is provided.

According to a modified embodiment, the comminution device is designed in such a way that an average distance between the central axes of the rolls is adjustable, and/or that an inclination of the central axes of the rolls relative to one another is adjustable and/or can be changed during comminution by forces from the comminution.

In particular, the first roll is arranged to be movable in translation relative to the second roll, namely movable transversely to the central axes. The comminution device can be designed in such a way that an average distance between the central axes of the rolls and/or an inclination of the central axes of the rolls relative to one another can be adjusted. During comminution, the inclination can also be changed due to forces from comminution, i.e. it can be permitted. In other words, play can be provided in the axes, which allows for inclination.

Embodiments described above are advantageous, for example, in order to remove jammed material to be comminuted, in order to be able to examine the corner block segment and/or in order to be able to replace the corner block segment more easily. This also improves or extends the most uninterrupted operation of the comminution device.

Finally, a comminution system is proposed. The system has the above-described comminution device and at least one further comminution device. A further comminution device, in particular a gyratory crusher and/or a cone crusher, can be provided upstream of the comminution device. In addition, a further comminution device can be provided downstream of the comminution device, in particular a tube mill.

For example, the comminution device according to the invention with the corner block segment can be arranged downstream of a gyratory crusher and/or a cone crusher, in particular directly. For example, the comminution device according to the invention can be arranged upstream, in particular directly, with the corner block segment of a tube mill. Directly downstream or upstream means here that no comminution device other than the affected comminution devices are arranged directly adjacent along a material flow direction. The comminution devices can still be located at a distance from one another; it is important here that no comminution takes place in the material flow between them. However, transport, sorting and/or screening should be possible.

Furthermore, an edge body is proposed for the corner block segment described above. The edge body is also suitable for the roll, the comminution device and/or for the system. In particular, the edge body has hard metal and/or tungsten carbide or is made of hard metal and/or tungsten carbide.

In particular, the edge body has the corner region or the segment outer side, at least in sections. The edge body can also have the receiving side and/or the segment end face, each at least in sections. The edge body and/or the corner region can be designed according to one or more of the above-described modified embodiments of the corner block segment.

In particular, the edge body has a projection and/or a recess corresponding to a/the projection for connecting the base body to the edge body-for example, facing away from the segment outer side. In this respect, one of the projections or recesses can be provided on the suitable base body. The edge body can also be advantageously developed using individual features that are mentioned above. The proposed edge body is an advantageous replacement part for repairing a worn corner block segment by replacing the edge body. Thanks to the hard metal/tungsten carbide, thanks to the corner region/the segment outer side or thanks to the projection/recess, an easy-to-use and highly wear-resistant individual part is proposed, which generally makes the use of the corner block segment even more cost-effective.

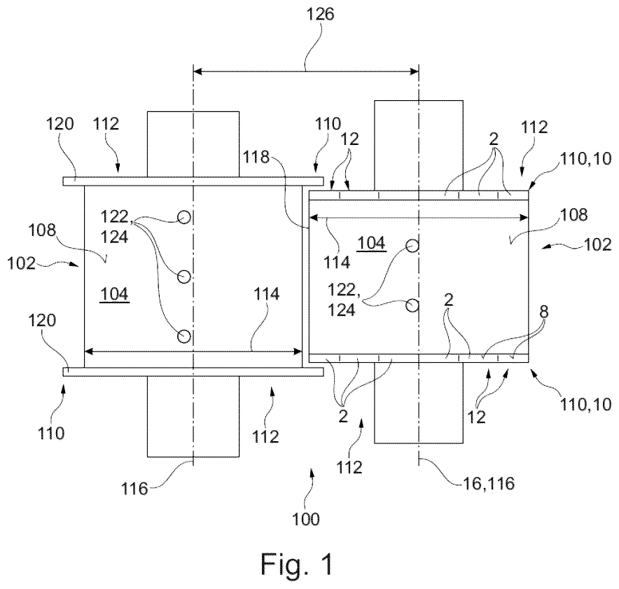

The abbreviation “or” is generally intended to indicate alternative and/or synonymous features/terms in order to convey the idea of using a feature or term more closely. “Or” can always be replaced with “and/or”. In the following, the invention is explained by way of example with reference to the attached drawings using preferred exemplary embodiments, wherein the features presented below can represent an aspect of the invention both individually and in combination. It goes without saying that the comminution device can be significantly improved by just individual features of the corner block segment. In this respect, features of the exemplary embodiments should also be used in isolation. In the following:
FIG. 1 shows a comminution device with two rolls, wherein one roll has corner block segments,

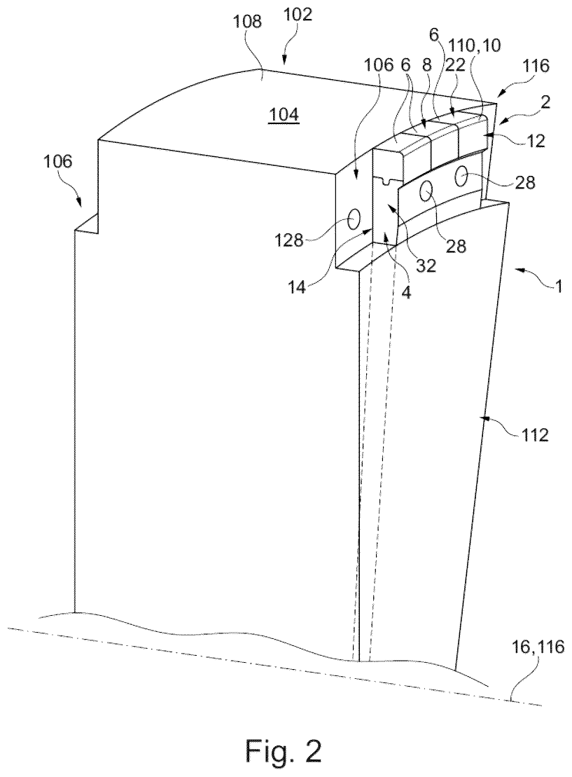

FIG. 2 shows a section of a roll with a single corner block segment in a perspective view,

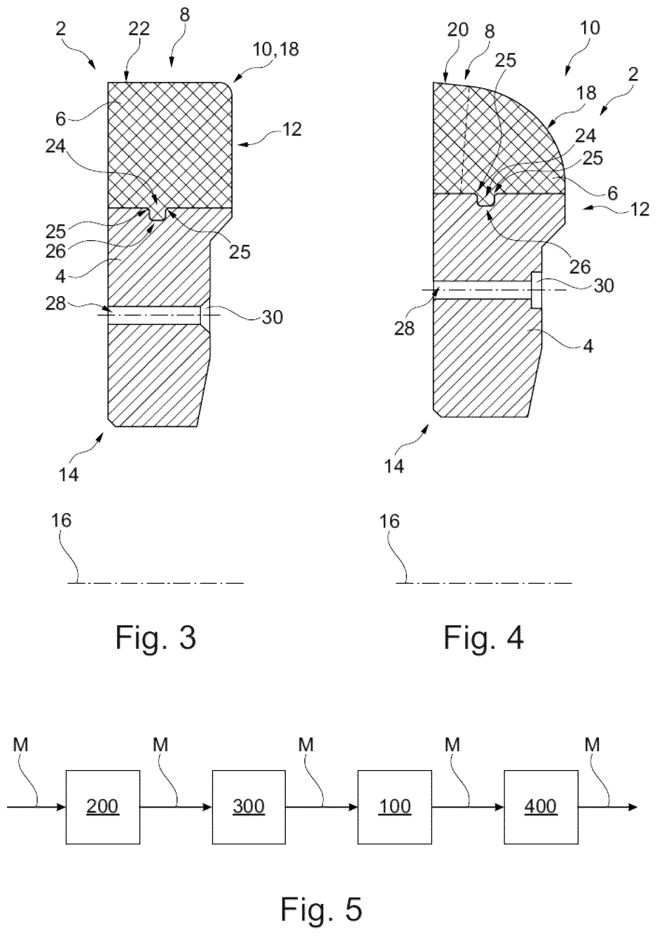

FIG. 3 shows a sectional view of a corner block segment according to the invention,

FIG. 4 shows a sectional view of another corner block segment according to the invention, and

FIG. 5 shows a schematic representation of a system according to the invention with a plurality of comminution devices.

FIG. 1 shows a comminution device 100 for comminution of material to be comminuted with a drive unit (not shown) and with two rolls 102 which can be rotated parallel to one another and can be driven in opposite directions and can be driven by the drive unit. The rolls 102 can each rotate about a central axis 116. The central axes 116 are spaced apart from one another.

The rolls 102 are configured and arranged in such a way that there is an adjustable working gap 118 for comminution between the rolls 102 or the working gap 118 is formed. The roll 102 (first roll 102) shown on the right in FIG. 1 is movable in translation relative to the other roll 102 in order to adjust the working gap 118 via the average distance 126 of the central axes 116 of the rolls 102 and to influence the comminution. An inclination of the central axes 116 of the rolls 102 relative to one another is also adjustable. The roll 102 (second roll 102) shown on the left in FIG. 1 has two radially projecting side walls 120 for delimiting the working gap 118 along the central axis 116. The side walls 120 can also rotate.

The (first) roll 102 has a plurality of corner block segments 2 attached to a metallic roll body 104 made of 18NiCrMo14-6 steel to form a roll edge 110.

The roll body 104, which is cylindrical on each roll 102, has two roll end faces 112 facing away from one another along the central axis 116 and an at least substantially cylindrical roll outer side 108 between the roll end faces 112.

The roll outer side 108 extends between the roll end faces 112 and forms a cylindrical sleeve or has a cylindrical sleeve.

The corner block segments 2 are each accommodated in an end-face segment receptacle 106 of the roll 102 in order to form the roll edge 110 through a corner region 10 of the corner block segments 2. The corner block segments 2 are accommodated here in such a way that a reference axis 16 of the corner block segments 2 runs coaxially to the central axis 116 of the roll 102, after which the corner block segment 2 is inserted into the segment receptacle 106 with a precise fit. The corner block segment 2 is constructed with a curvature around the reference axis 16 to match the diameter 114 of the roll 102 or to match/correspond to the segment receptacle 106.

The two rolls 102 of FIG. 1 each have cylindrical receptacles 122 for wear bodies 124 which are arranged pointing transversely to the central axis 116, accessible on the roll outer side 108 and distributed circumferentially on the roll outer side 108. In the present case, two such receptacles 122 in the form of blind hole bores can be seen on the (first) roll 102. Another six receptacles 122 are distributed around the central axis 116, but are not obvious from the view. Two times four of the eight receptacles 122 are arranged rotationally symmetrically along a circle of rotation of the roll body 104 or the roll 102 that is imaginary or formed around the central axis 116, and the four of the receptacles 122 are placed per circle of rotation at an angular distance of 90° from one another around the central axis 116. In the first roll 102, the two circles of rotation are provided spaced apart or distributed along the central axis 116.

Cylindrical wear bodies 124 made of hard metal are glued into the receptacles 122. The wear bodies 124 are cylindrical, rod-shaped and bolt-shaped.

The two rolls 102 or roll bodies 104 have an at least substantially the same diameter 114.

With reference to FIG. 2, a section of a roll 102 with two segment receptacles 106 for corner block segments 2 is shown—in the shape of a pie slice for clarity. A single corner block segment 2 is attached to the roll body 104 of the roll 102. The corner block segment 2 forms a roll edge 110 through a corner region 10 of the corner block segment 2, wherein the roll 102 is assigned or is to be assigned to a comminution device 100 for comminuting material to be comminuted and is designed to rotate about a central axis 116 of the roll 102.

The corner block segment 2 has a metallic base body 4 made of steel of grade S355 and an edge body 6. The corner block segment 2 has a substantially cylinder sleeve section-shaped or cylindrical and therefore curved segment outer side 8, adjacent to it the corner region 10, adjacent to the corner region 10 a segment end face 12 and a receiving side 14. The receiving side 14 corresponds to the segment receptacle 106 and is arranged facing away from the corner region 10. The receiving side 14 can lie flat in the segment receptacle 106 and is therefore well suited for force transmission.

The segment outer side 8, the corner region 10, and the segment end face 12 are each fixed to the base body 4, in particular in such a way that the edge body 6 is connected to the base body 4. The corner region 10 is arranged between the segment outer side 8 and the segment end face 12 to form the roll edge 110.

Viewed detached from the roll 102, the corner block segment 2 is at least substantially shaped like an circular ring sector about an imaginary reference axis 16 of the corner block segment 2. The reference axis 16 is arranged outside the corner block segment 2. The reference axis 16 coincides with the central axis 116 on the roll 102. The segment outer side 8 is arranged facing away from the reference axis 16.

In the present case, the corner region 10 has a radius 18 of at least 1 mm, in particular in the longitudinal section through the reference axis 16. In the present case, the radius 18 is 5 mm+/−2.5 mm. The corner region 10 is designed convex.

With an (imaginary) clear separation of the segment outer side 8 and the corner region 10, the segment outer side 8 in the present case does not have a section 20 that is pointed towards the corner region 10. To the extent that an (imaginary) smooth transition is allowed between the segment outer side 8 and the corner region 10, the segment outer side 8 therefore has a pointed section 20 because this is in the nature of the radius 18 on the roll edge 110.

The segment outer side 8 borders seamlessly and continuously the corner region 10.

The segment outer side 12 borders seamlessly and continuously the corner region 10.

The segment outer side 8 is designed cylindrical or in the shape of a cylinder sleeve section. In the present case, in the longitudinal section through the reference axis 16 and the central axis 116, the segment outer side 8 borders on the one hand the corner region 10 and on the other hand the roll outer side 108, and this seamlessly or continuously.

The corner block segment 2 has the three-part edge body 6 connected or soldered to the base body 4.

The edge body 6 consists at least substantially of a hard metal of grade B30 or B40. The edge body 6 has in particular tungsten carbide.

The edge body 6 has the corner region 10, the segment outer side 8 and part of the segment end face 12. The remaining part of the segment end face 12 is located on the base body 4.

The base body 4 is equipped with an opening 28 pointing along the reference axis 16 or extending along the reference axis 16 for releasable connection or attachment to the roll body 104 by means of screwing. This means that the rather ductile base body 4 can be attached and the rather hard and wear-resistant edge body 6 can come into contact with the material to be comminuted.

In the circumferential direction around the reference axis 16 or central axis 116, the corner block segment 2 can come into contact via a flat contact side 32 with a flat contact side 32 of a further corner block segment (not shown). The contact side 32 is located partly on the base body 4 and partly on the edge body 6. The contact side 32 runs parallel to the reference axis 16.

The segment receptacle 106 is constructed to be curved all around the central axis 116.

The segment receptacle 106 has a distance from the central axis 116 which corresponds to the distance of the corner block segment 2 or the physical components of the corner block segment 2 from the reference axis 16. The segment receptacle 106 is curved in the same way as the corner block segment 2. The segment receptacle 106, in cross-section through the central axis 116, substantially corresponds to a surface of the corner block segment 2 in the cross-section through the reference axis 16.

With reference to FIG. 3, a sectional view of the corner block segment 2 of FIG. 2 is shown along the reference axis 16 or in longitudinal section. As can be seen, the edge body 6 and the base body 4 are positively connected to one another by means of a projection 24 on the edge body 6 and a recess 26 on the base body 4 corresponding to the projection 24 and soldered in this arrangement with an enlarged area. This positive and cohesive connection thanks to the soldering and thanks to the projection 24 and recess 26 enables a transmission of even high forces along the reference axis 16 between the base body 4 and the edge body 6.

The projection 24 and the recess 26 are formed curved about the reference axis 16. The projection 24 and the recess 26 run at least substantially along or in an imaginary plane that is arranged orthogonally to the reference axis 16, around the reference axis 16.

The projection 24 is arranged facing away from the segment outer side 8.

The reference axis 16 can be seen in the lower region of FIG. 3. The reference axis 16 runs outside of the physical extent of the corner block segment 2. The reference axis 16 represents an axis of symmetry around which the base body 4 and the edge body 6 are at least substantially curved. In the present case, the reference axis 16 runs parallel to the segment outer side 8 and parallel to part of the receiving side 14.

The base body 4 and the edge body 6 each have a section of the segment end face 12. In this case, the two sections merge seamlessly into one another.

The base body 4 and the edge body 6 each have a section of the receiving side 14. In this case, the two sections merge seamlessly into one another.

The receiving side 14 is designed substantially L-shaped.

The receiving side 14 has a chamfer between the two L-legs, which means that contaminants in the segment receptacle 106 can be picked up without any problems and whereby the risk of injury is reduced.

The segment end face 12 is designed at least substantially stepped. In particular, the segment end face 12 is substantially tapered or pointed in sections along the sides of the edge body 6 towards the reference axis 16. This saves material.

The opening 28 for releasable attachment to the roll body 104 is provided with a conical indentation 30 or depression on the segment end face 12.

With reference to FIG. 4, a further corner block segment 2 according to the invention is shown, which is substantially similar to the corner block segment 2 of FIG. 3. Deviating from this, the radius 18 is significantly enlarged at 25 mm. In addition, the opening 28 has a shoulder as an indentation 30 instead of the conical indentation 30. Furthermore, the projection 24 of the edge body is provided with relief regions 25 to reduce the notch effect; in the course of this, the recess 26 also has material withdrawals or chamfers corresponding to the relief regions 25, so that the relief regions 25 can be accommodated therein. In particular, this increases the force that can be transmitted by the connection—typically soldering—between the base body 4 and the edge body 6.

Further deviating from FIG. 3, the corner block segment 2 of FIG. 4 has a section 20 that is pointed towards the corner region 10. The pointed section 20 is conical and transitions seamlessly or continuously into the corner region 10. Nevertheless, the pointed section 20 does not border the corner region 10 parallel to the reference axis 16 or transversely to the receiving side 14. In this respect, the corner block segment 2 will form a blunt, non-continuous or seamless transition to the roll outer side 108 when in use.

Not shown is an embodiment in which a base body 4 and an edge body 6 are designed monolithically or in one piece, i.e. are manufactured in one piece. A connection between the base body 4 and the edge body 6 in the form of soldering, screwing or the like can be omitted. In such an embodiment, base body 4 and edge body 6 can be understood as synonymous.

A system according to the invention is shown in FIG. 5. In the system, four comminution devices 100, 101 are arranged one behind the other in a material flow direction M, so that the feed material is gradually smaller and smaller following the material flow direction M. Three comminution devices 101 of the four comminution devices 100, 101 are so-called further comminution devices 101 in the form of a gyratory crusher 200, a cone crusher 300 and a tube mill 400.

First, comminution can take place in the gyratory crusher 200. Comminution can then take place in the cone crusher 300. Afterwards, comminution can take place in the comminution device 100 according to the invention, which is designed as a roller press. Comminution can then take place in the tube mill 400. In the system, a large number of corner block segments 2 according to the invention are used in the comminution device 100.

### LIST OF REFERENCE NUMERALS

2 corner block segment
4 base body
6 edge body
8 segment outer side
10 corner region
12 segment end face
14 receiving side
16 reference axis
18 radius
20 pointed section
22 cylinder sleeve section-shaped section
24 projection
25 relief region
26 recess
28 opening
30 indentation
32 contact side
100 comminution device
101 further comminution device
102 roll
104 roll body
106 segment receptacle
108 roll outer side
110 roll edge
112 roll end face
114 diameter
116 central axis
118 working gap
120 side wall
122 receptacle
124 wear body
126 distance
128 opening
200 gyratory crusher
300 cone crusher
400 tube mill
M material flow direction

1. Corner block segment (2) for attachment to a cylindrical roll body (104) of a roll (102) of a comminution device (100) for comminuting material to be comminuted, wherein the roll (102) is designed to rotate about a central axis (116) of the roll (102), the corner block segment (2) having
a base body (4),
a segment outer side (8) attached to the base body (4),
a segment end face (12) attached to the base body (4),
a corner region (10) attached to the base body (4) between the segment outer side (8) and the segment end face (12) to form a roll edge (110) of the roll (102), and
a receiving side (14) attached to the base body (4),
wherein the receiving side (14) corresponds to a segment receptacle (106) of the roll body (104) and is arranged facing away from the corner region (10),
wherein the corner block segment (2) is at least substantially shaped like a sector of a circular ring or a sector of a circle around an imaginary reference axis (16) of the corner block segment (2),
wherein the segment outer side (8) is curved and is arranged facing away from the reference axis (16), and
wherein in the longitudinal section through the reference axis (16), the corner region (10) has a radius (18) of at least 5 mm, and, preferably, wherein in the longitudinal section through the reference axis (16), the segment outer side (8) has at least one section (20) pointed towards the corner region (10).

2. Corner block segment (2) according to claim 1, wherein the radius (18) is at least 10 mm and/or up to and including 40 mm, preferably at least 20 mm and/or up to and including 30 mm.

3. Corner block segment (2) according to claim 1 or 2, wherein the segment outer side (8) is conical and/or wherein the segment outer side (8) adjoins the corner region (10) in particular seamlessly and/or continuously.

4. Corner block segment (2) according to any one of the preceding claims, wherein the pointed section (20), in particular seamlessly and/or continuously, adjoins a cylinder sleeve section-shaped section (22) of the segment outer side (8).

5. Corner block segment (2) according to any one of the preceding claims, having at least one edge body (6) connected, in particular soldered, to the base body (4), in particular wherein the edge body (6) has hard metal and/or tungsten carbide or is made of hard metal and/or tungsten carbide.

6. Corner block segment (2) according to claim 5, having, for connecting the base body (4) to the edge body (6) or to the edge bodies (6),
a projection (24) and
a recess (26) corresponding to the projection (24).

7. Corner block segment (2) according to any one of the preceding claims,
wherein the base body (4) has the corner region (10) and/or the segment outer side (8), or
wherein the edge body (6) has the corner region (10) and/or the segment outer side (8).

8. Corner block segment (2) according to any one of the preceding claims, wherein the base body (4) has an opening (28) extending along the reference axis (16) for releasable connection to the roll body (104), for example by means of screwing.

9. Roll (102) for a comminution device (100) for comminuting material to be comminuted and designed to rotate about a central axis (116) of the roll (102), the roller
(102) having
at least one corner block segment (2) according to any one of the preceding claims,
a cylindrical roll body (104) with a segment receptacle (106) for the corner block segment (2),
wherein the roll body (104) has two roll end faces (112) facing away from one another along the central axis (116), and is designed with a roll outer side (108) which extends between the roll end faces (112) and forms a cylinder sleeve,
wherein the segment receptacle (106) is arranged on at least one of the roll end faces (112) for the corner block segment (2) to form a roll edge (110) through the corner region (10) of the corner block segment (2),
wherein the corner block segment (2) is accommodated in the segment receptacle (106) in such a way that the reference axis (16) and the central axis (116) run coaxially or parallel.

10. Roll (102) according to claim 9, wherein the roll body (104) has receptacles (122) for wear bodies (124) and/or connecting regions for wear bodies (124) which point
transversely to the central axis (116), are accessible on the roll outer side (108) and are arranged circumferentially distributed on the roll outer side (108), wherein preferably the receptacles (122) are cylindrical and/or rod-shaped and/or bolt-shaped.

11. Roll (102) according to claim 9 or 10, further having the wear bodies (124) on the 15 roll outer side (108), in particular wear bodies (124) introduced into the receptacles (122) and/or connected to the receptacles (122) and/or to the connecting regions (124), for example soldered or glued wear bodies (124), wherein the wear bodies (124) preferably have hard metal and/or are designed cylindrical.

12. Comminution device (100) for comminuting material to be comminuted with a drive unit and with two rolls (102) which can be rotated parallel to each other in opposite directions about a central axis (116) and can be driven by means of the drive unit, wherein the rolls (102) are configured and arranged in such a way that between the rolls
(102) an adjustable working gap (118) for comminution is formed, wherein the first roll (102) is designed according to any one of claims 9 to 11, wherein preferably the second roll (102) has radially projecting side walls (120) to limit the working gap (118) along the central axes (116).

13. Comminution device (100) according to claim 12, configured such that a mean distance (126) of the central axes (116) of the rolls (102) to one another is adjustable, and/or such that an inclination of the central axes (116) of the rolls (102) to one another is adjustable and/or can be changed during comminution by forces from comminution.

14. System for comminution, having
a comminution device (100) according to any one of claims 12 or 13 as well as
a further comminution device (101) upstream of the comminution device (100), in particular a gyratory crusher (200) and/or cone crusher (300), and/or a further
comminution device (101) downstream of the comminution device (100), in particular a tube mill (400).

15. Edge body (6) for the corner block segment (2) according to any one of claims 1 to 8,
wherein the edge body (6) has hard metal and/or tungsten carbide or is made of hard metal and/or tungsten carbide,
wherein the edge body (6) has the corner region (10) according to any one of claims 1 to 8 and the segment outer side (8) according to any one of claims 1 to 8, and
wherein the edge body (6) has a projection (24) or a recess (26) corresponding to a projection (24) for connecting the base body (4) to the edge body (6), for example facing away from the segment outer side (8).
